(19) United States
(12) Patent Application Publication
(10) Pub. No.: US 2007/0175388 A1
(43) Pub. Date: Aug. 2, 2007

(54) Art creation device

(76) Inventors: Jeremy Deeble, Boise, ID (US); Mindy Deeble, Boise, ID (US)

Correspondence Address: ROBERT L. SHAVER;DYKAS, SHAVER & NIPPER, LLP, PO BOX 877, BOISE, ID, 83701-0877, US

(21) Appl. No.: 11/342,154

(22) Filed: Jan. 27, 2006

(51) Int. Cl. B05C 13/00

(52) U.S. Cl. 118/500

(57) ABSTRACT

An art creation device which utilizes a heated surface to melt crayons on a sheet of paper. The paper is held in place by paper clamps, and the device includes a temperature control thermostat, a heated surface, and a heat insulated border and base.

### FIELD OF THE INVENTION

The present invention generally relates to devices for creating art, and more specifically for devices which utilize heat in order to melt crayons to make an art work.

### BACKGROUND OF THE INVENTION

Crayons have long been a staple in the elementary school teacher's bag of tricks to encourage students to make artwork and to have fun in the creation of artwork. Every school has crayons as they are relatively inexpensive. An art device which utilizes crayons would be an asset to any art class, elementary school or as a fun craft project for creative people of any age.

One drawback in the use of crayons is that in order to get a deep color, one has to work very hard at applying many layers of crayon to a single spot. What is needed is a device which is built to hold a piece of paper and to enable a user to utilize crayons to achieve a richer, more vibrant color than is presently possible with crayon application. This is accomplished in the device of the invention by use of heat in the device to melt crayons as they are applied.

### SUMMARY OF THE INVENTION

The invention is an art creation device which utilizes a built-in heat source to melt crayons as the crayons are applied to a sheet of paper which is held in place in the device. The device includes a flat heating surface, which supports a sheet of paper. The device body includes the heating surface and one or more paper clamps for securing the sheet of paper in place in the device. By applying heat below the paper and securing the paper in place, the art creation device of the invention causes crayons to melt as the crayon is pressed against the heated surface of the paper. The melted crayon has a much deeper and more vibrant color than crayon which is applied by rubbing on cold paper. Additionally, as crayon is applied to the sheet of paper, the different colors of crayon can be blended together to form shades and patterns and colors which are otherwise impossible to form without melting crayons.

Preferably the heat source is positioned directly below the heating surface, and is configured to leave a zone around the outside edge of the heating surface which is not heated, so that melted crayon wax does not tend to escape from the paper surface, and so that the edges of the paper can be utilized by the paper clamps to hold the paper in place. The heating surface is preferably made or covered by a non-stick material such as Teflon, nylon, silicon, or any number of materials which can be used separately or used as a coating over a metal surface. The device includes a thermostat which allows the temperature of the heating surface to be set at a temperature above the melting point of crayons, but at a low enough temperature so that burns to the user are not a risk. The thermostat can be accessible by the user, so that different temperature levels can be utilized, or can be built into the electronic circuitry of the unit and preset at the factory. The device also includes a raised border around the heating surface, with the border being thermally insulated from the heat source, so that the user may touch the raised border without discomfort from heat. The heating surface and the surrounding raised border may be formed from a seamless basin, to prevent melted wax from passing through a seam and to make cleanup of the device easy.

The paper clamps can be configured in various different ways, and one or more paper clamps can be utilized. The paper clamps can be in the form of bias clips, which hold the paper in place. The paper clamps can also be in the form of magnetic sections which hold the paper down along its edges. Other mechanical and well-known devices can also be utilized to hold the paper in place.

The art creation device of the invention can include a cover which may be utilized to close the device when it is not in use, and to enclose accessories for the device within the raised border for storage and transportation. This could include the crayons that are used with the device, a power cord used with the device, extra paper and cleanup materials for the device.

The cover can be attached to the body of the device by use of hinges, and it could also be provided with the feature of being removable from the body of the device. The cover could also serve as an additional heat shield and be removed from the top of the device and placed on the underside of the device to serve as additional insulation. The raised border preferably acts as a barrier to heat, and is made of material which is not a good conductor of heat, or is insulated with such a material so that the raised border does not become hot. The art creation device of the invention can include a built-in crayon holder which can take various forms. It can be built into a part of the raised border of the device, or a crayon holder could also be built into the cover of the device. The device could include an on/off switch but could also be activated merely by plugging the device into a power source. The device would typically be powered by wall current, but a battery powered version of the device or a device which runs on 12 volt is also possible.

The purpose of the foregoing summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the invention of the application, which is measured by the claims, nor is it intended to be limiting as to the scope of the invention in any way.

Still other objects and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of the art creation device of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

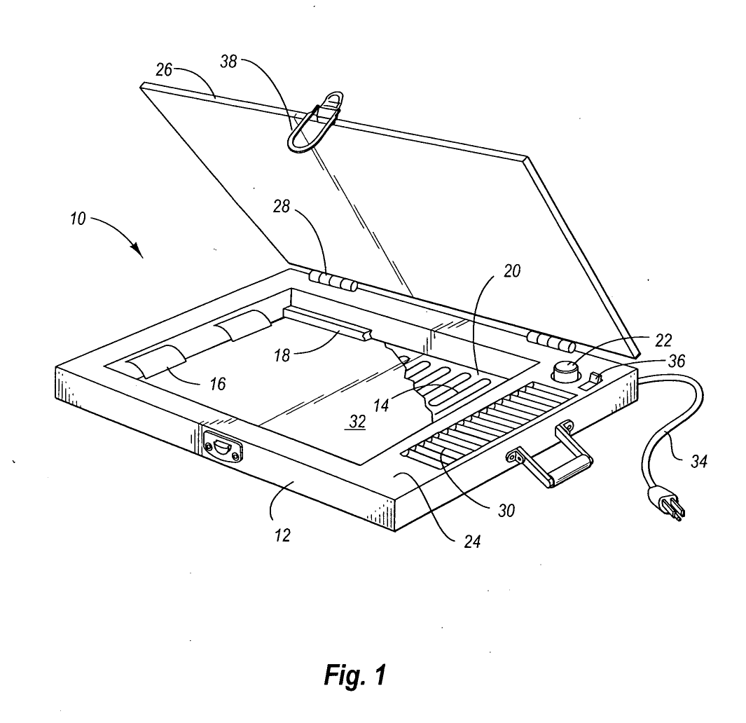

A preferred embodiment of the invention is shown in FIG. 1. FIG. 1 shows an art creation device 10 of the invention which includes a body 12, a heat source 14, a heating surface 32 and paper clamps 16. The body of the art creation device can be in various sizes, and would preferably be sized to accommodate standard sizes of paper such as 8½×11, 11×14, and 11×17. The heating surface is preferably a metal covered with a non-stick surface such as Teflon. The heating surface 32 is surrounded by a raised border 24, and can be made contiguous with the raised border 24 so that a seamless basin is formed in the interior of the device body 12. This would be provided so that melted crayons would not escape through a seam and to make cleanup of the device easier.

The heating surface 32 is preferably constructed with a heat source 14 directly below it. The heat source 14 can take any number of conventional forms of heating structures, including a structure with copper strips or wires affixed to a matrix, which provide heat when electricity is passed through them. An important feature of the device is that the elements of the heat source 14 do not extend all the way to the edge of the heating surface 32. A non-heated zone 20 is provided around the periphery of the heating surface. This feature tends to help prevent melted wax from escaping pass the edge of the sheet of the paper, and allows the edges of the sheet of paper to be utilized by the paper clamps 16.

As shown in FIG. 1, the paper clamps 16 can be a biased metal clip 16 or it can be a magnetic paper clamp 18. In the case of the magnetic paper clamp, magnetic strips are placed along the edge of the strip of paper and holds the sheet of paper in place between the magnetic paper clamps 18 and a magnetic strip below the surface of the heating surface.

The art creation device 10 includes a thermostat 22. The thermostat 22 can be as shown in FIG. 1, which is accessible to the user and adjustable to a desired temperature. The thermostat can also be built into the circuitry of the device, and set at the factory for a temperature above the melting point of crayon wax, but below a temperature range which would cause a burn to the user. A thermal safety shut-off can also be provided which would act like a fuse and prevent the heat source 14 from making the heating surface 32 hot enough to burn a user. The body 12 and the raised border 24 of the device are either made from a material which is not heat conductive or insulated, so that heat is not significantly conducted from the heat source to areas where the user would be likely to touch.

The device can optionally include a cover as shown in FIG. 1. A cover 26 is shown in FIG. 1. A cover 26 is attached to the art creation device body 12 by hinges 28. The cover can be opened to a position in which it can serve as a holder for artistic materials, or in another configuration, could be removed from the hinges 28 and snapped into place on the underside of the unit in order to provide additional heat shielding to the user. The unit can include a power switch 36 by which the unit is turned on or off. The unit can also be activated merely by plugging in a power cord 34. The cover includes a latch 38 which allows the cover to be snapped into place on the body 12 and locked. The cover allows the region inside the raised border 24 and on top of the heating surface 32 to be utilized as a storage area for materials such as paper, crayons, the power cord and clean-up materials. A crayon holder 30 can be built into the device, either in the raised border as shown in FIG. 1, or attached to the inside of the cover 26.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. An art creation device for use with paper and crayons, comprising:
a device body which is comprised of a generally planar heating surface configured to support an attached sheet of paper, and to have outside edges;
a heat source for heating said heating surface; and
one or more paper clamps for securing said sheet of paper to said planar heating surface;
in which the art creation device is configured to secure a sheet of paper on said heating surface using said paper clamps, and by heat from said heat source melting a crayon as it is pressed against said paper, so that art creations of melted crayons may be formed on said sheet of paper.

2. The art creation device of claim 1 in which said heat source is positioned below the heating surface.

3. The art creation device of claim 2 in which heat source doesn't extend to the outside edges of the heating surface, leaving a non-heated zone around the outside edge of the heating surface.

4. The art creation device of claim 1 in which the heating surface is formed of a non-stick material.

5. The art creation device of claim 1 which further comprises a thermostat preset to a temperature near the melting point of crayon wax.

6. The art creation device of claim 1 which further comprises a raised border around the planar heating surface.

7. The art creation device of claim 6 in which said raised border is designed to be seamless in nature, to prevent the escape of melted crayon wax.

8. The art creation device of claim 1 in which said paper clamps are comprised of one or more biased clips.

9. The art creation device of claim 1 in which paper clamps are in the form of magnetic hold paper downs.

10. The art creation device of claim 1 which includes a cover that attaches to the device body.

11. The art creation device of claim 10 in which said cover attaches by one or more hinges.

12. The art creation device of claim 1 which further comprises a heat barrier around said heating surface.

13. The art creation device of claim 1 which further comprises one or more handles for carrying said device.

14. The art creation device of claim 1 which further includes a temperature limit switch that shuts down said heat source at a selected temperature.

15. The art creation device of claim 1 which further comprises a heat insulated border around said heating surface.

16. The art creation device of claim 15 which further comprises a crayon holder built into said heat insulated border.

17. An art creation device for use with paper and crayons, comprising:
a device body which is comprised of a raised border around a generally planar heating surface with outside edges and formed of a non-stick material, configured to support an attached sheet of paper;
a heat source positioned below said heating surface for heating said heating surface, with said heat source extending toward the outside edges of the heating surface, leaving an unheated portion adjacent to the heating surface;
a thermostat for selecting a maximum temperature of said heat source; and
one or more paper clamps for securing said sheet of paper to said planar heating surface;
in which the art creation device is configured to secure a sheet of paper on said heating surface using said paper clamps, and by heat from said heat source melting a crayon as it is pressed against said paper, so that art creations of melted crayons may be formed on said sheet of paper.

18. The art creation device of claim 1 in which said paper clamps are comprised of one or more biased clips.

19. The art creation device of claim 1 in which paper clamps are in the form of magnetic hold paper downs.

20. An art creation device for use with paper and crayons, comprising:
a device body which is comprised of a raised border around a generally planar heating surface with outside edges and formed of a non-stick material, configured to support an attached sheet of paper, with said heating surface adjacent to a heat barrier;
a heat source positioned below said heating surface for heating said heating surface, with said heat source extending toward the outside edges of the heating surface, leaving an unheated portion adjacent to the heating surface;
a thermostat for selecting a maximum temperature of said heat source; and
one or more paper clamps for securing said sheet of paper to said planar heating surface;
in which the art creation device is configured to secure a sheet of paper on said heating surface using said paper clamps, and by heat from said heat source melting a crayon as it is pressed against said paper, so that art creations of melted crayons may be formed on said sheet of paper.
